(19) United States
(12) Patent Application Publication
(10) Pub. No.: US 2010/0059657 A1
(43) Pub. Date: Mar. 11, 2010

(54) System and Method Producing Data For Correcting Autofocus Error in An Imaging Optical System

(75) Inventors: Daniel G. Smith, Oro Valley, AZ (US); David M. Williamson, Tucson, AZ (US); Michael Sogard, Menlo Park, CA (US)

Correspondence Address: LAWRENCE R. OREMLAND, P.C., 5055 E. BROADWAY BLVD., SUITE C-214, TUCSON, AZ, 85711, US

(73) Assignee: Nikon Corporation, Tokyo (JP)

(21) Appl. No.: 12/205,027

(22) Filed: Sep. 5, 2008

(51) Int. Cl. G02B 7/04; G01N 21/55

(52) U.S. Cl. 250/201.2; 356/445

(57) ABSTRACT

A new and useful system and method is provided, for correcting autofocus errors in an imaging optical system. In a system or method according to the present invention (a) an optical test assembly with an input portion directs light at a wafer surface under conditions described by ellipsometric input beam conditioning parameters, and an output/detection portion receives reflected light from the wafer under conditions described by ellipsometric output beam conditioning parameters, and produces output based on the received reflected light; and (b) a processing control circuit processes the output of the optical test assembly, and produces autofocus correction data based on ellipsometric analysis of (i) the ellipsometric input and output beam conditioning parameters and (ii) the output of the optical test assembly.

### BACKGROUND

The present invention relates to a new and useful system and method that produces data for correcting autofocus error in an imaging optical system

In U.S. application Ser. No. 11/544,833, filed Oct. 5, 2006, assigned to the assignee of the present invention, and incorporated by reference herein, there is disclosed a system providing control information for an imaging optical system such as a lithographic imaging optical system. In that system, imaging optics define a primary optical path along which a primary image is projected (e.g. onto a wafer), and a measurement optical path is established and includes at least part of the primary optical path. The imaging optical system is configured to obtain information from the measurement optical path for use in providing control information for the imaging optical system. The system includes, e.g. optics, detectors, electronics, mechanics, etc., which detect the information from the measurement optical path, and produce control data that are useful in the imaging optical system. The metrology features that are provided by the system of that application are sometimes referred to by applicants as “through the lens” metrology, because the measurement optical path, in those cases, is at least partially through the primary optical path.

Often a wafer that is imaged by a system such as shown in U.S. patent application Ser. No. 11/544,833 is a multilayer structure, and when light is reflected from such a multilayer structure during exposure, the phase and polarization of a reflected beam is strongly dependent on the angle of incidence, polarization and wavelength of the incident beam as well as the nature of the multilayer structure itself. At the precision desired for imaging a wafer, this phase change on reflection can fluctuate by more than the focus tolerances desirable (e.g. due to normal variations in the resist structure and to variations in the materials of the layers beneath the resist).

### SUMMARY OF THE INVENTION

The present invention provides new and useful system and method concepts that are specifically designed to account for (i.e. effectively recover) autofocus error that can be produced in an optical imaging system, particularly a lithographic wafer imaging system, where lithographic imaging a wafer whose top surface is made up of multiple layers of material can produce autofocus errors that should be accounted for in the control data that are used to control the system.

The system and method of the present invention apply ellipsometric principles to produce autofocus correction data in an imaging optical system. For example, the present invention manipulates (controls) one or more beam conditioning parameters (input or output), using ellipsometry principles, to produce control data that recover autofocus phase error introduced by imaging a wafer made up of multiple layers of material. Such autofocus correction data are designed to improve the level of accuracy of an optical imaging system that images a wafer.

The principles of the present invention are designed to be used to correct autofocus error in an optical imaging system that uses the “through the lens” metrology of the type disclosed in U.S. patent application Ser. No. 11/544,833, and are also designed to be used in an optical imaging system where a measurement optical path may be outside the primary optical path.

A system or method according to the present invention comprises (a) an optical test assembly with an input portion that directs light at a wafer surface under conditions described by ellipsometric input beam conditioning parameters, and an output/detection portion that receives reflected light from the wafer under conditions described by ellipsometric output beam conditioning parameters, and produces output based on the received reflected light; and (b) a processing control circuit that processes the output of the optical test assembly, and produces autofocus correction data based on ellipsometric analysis of (i) the ellipsometric input and output beam conditioning parameters and (ii) the output of the optical test assembly.

According to a preferred form of the present invention, the ellipsometric input beam conditioning parameters comprise phase shifting, polarization, input beam wavelength(s), input beam direction(s), and combinations of the foregoing. In addition, the ellipsometric output parameters comprise phase shifting, polarization filtering, chromatic filtering, spatial filtering, and combinations of the foregoing. Moreover, the spatial filtering may be configured to reduce (and preferably eliminate) diffracted light and unwanted reflected light from various surfaces in the received reflected light that produces the output, and such spatial filtering may be produced by one or more filters located in the output/detection portion of the optical test assembly.

The principles of the present invention may be employed in a wafer imaging system and method in various ways to correct for autofocus error. In one alternative, the optical test assembly and processing control circuit are configured to pre-map the wafer surface prior to imaging the wafer, to produce the auto focus correction data during imaging of the wafer. In another alternative, the optical test assembly and processing control circuit are configured to partially pre-map the wafer surface prior to imaging of the wafer surface, and to also operate the optical test assembly and processing circuit in situ during imaging of the wafer surface to produce the auto focus correction data during the imaging of the wafer. In yet another alternative, the optical test assembly and processing control are operated in situ during imaging of the wafer surface to produce the auto focus correction data during the imaging of the wafer.

Other features of the present invention will become further apparent from the following detailed description and the accompanying drawings.

### BRIEF DESCRIPTION OF THE DRAWINGS

FIG. 1 is a schematic illustration of a lithographic imaging optical system with which the principles of the present invention can be used;

FIG. 2 shows an imaging optical system that has a metrology system of the “through the lens” type, and which is configured according to the principles of the present invention;

FIG. 3 is a schematic illustration of the manner in which the principles of the present invention are employed to produce data for correcting autofocus error in a wafer imaging system;

FIG. 4 is a schematic illustration of one way of providing spatial filtering as an output beam parameter, according to one embodiment of the present invention;

FIG. 5 is a ray picture of the field directions of a transverse electric wave incident on a plane surface;

FIG. 6 is a ray picture of the field directions of a transverse magnetic wave incident on a plane surface;

FIG. 7 is an illustration of a ray incident on a single thin film deposited on a substrate;

FIG. 8 is an illustration of a ray incident on a multilayer film deposited on a substrate;

FIG. 9 is an illustration of a simple interferometric ellipsometer concept, showing a reference beam that reflects off of an air-glass interface and is subsequently interfered with a measurement beam that reflects off of a wafer thin film assembly;

FIG. 10 is a plot of the simulated ellipsometric parameters Δ vs ψ as the thickness of the resist is varied from zero to 523 nm; and

FIG. 11 is a plot of the simulated ellipsometric parameters Δ vs ψ as the thickness of the resist is varied to trace out the contours of equal index of refraction.

### DETAILED DESCRIPTION

As discussed above, the present invention relates to a new and useful system and method that produces data for correcting autofocus error in an imaging optical system. The following description provides the basic structural and operational principles of the system and method of the present invention, and also to how the principles of the present invention may be applied to a “through the lens” (TTL) metrology system of the type described in U.S. patent application Ser. No. 11/544,833. From that description, the manner in which the principles of the present invention can be applied to correct autofocus phase error in various types of optical imaging systems and methods will become clear to those in the art.

### GENERAL DESCRIPTION OF STRUCTURAL AND OPERATIONAL PRINCIPLES OF SYSTEM AND METHOD OF THE PRESENT INVENTION

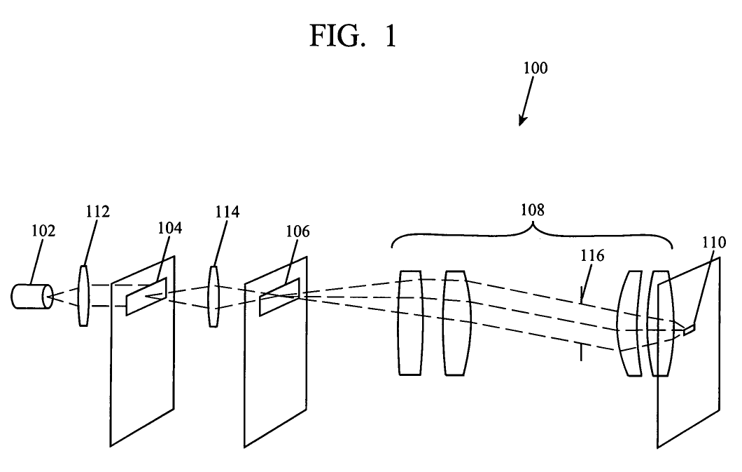

FIG. 1 schematically illustrates an imaging optical system 100 of the type that would be useful in a lithographic imaging optical system. The imaging optical system system 100 comprises a radiation (e.g. light) source 102, a scanning slit 104 that is used to direct a scanning beam through an object (or reticle) 106, and primary imaging optics 108 that image the scanned object onto an image plane 110. Such aspects of a lithographic imaging optical system are well known and should not require further description to those in the art. The system 100 also includes illumination optics 112, 114 and a pupil 116 that would be well known to those in the art, and should not require further explanation.

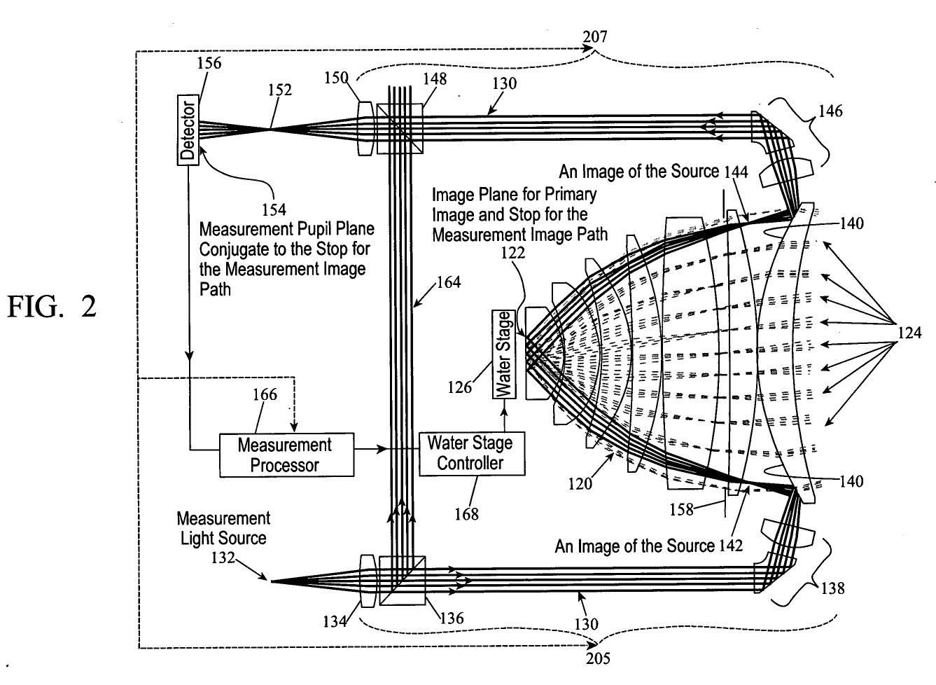

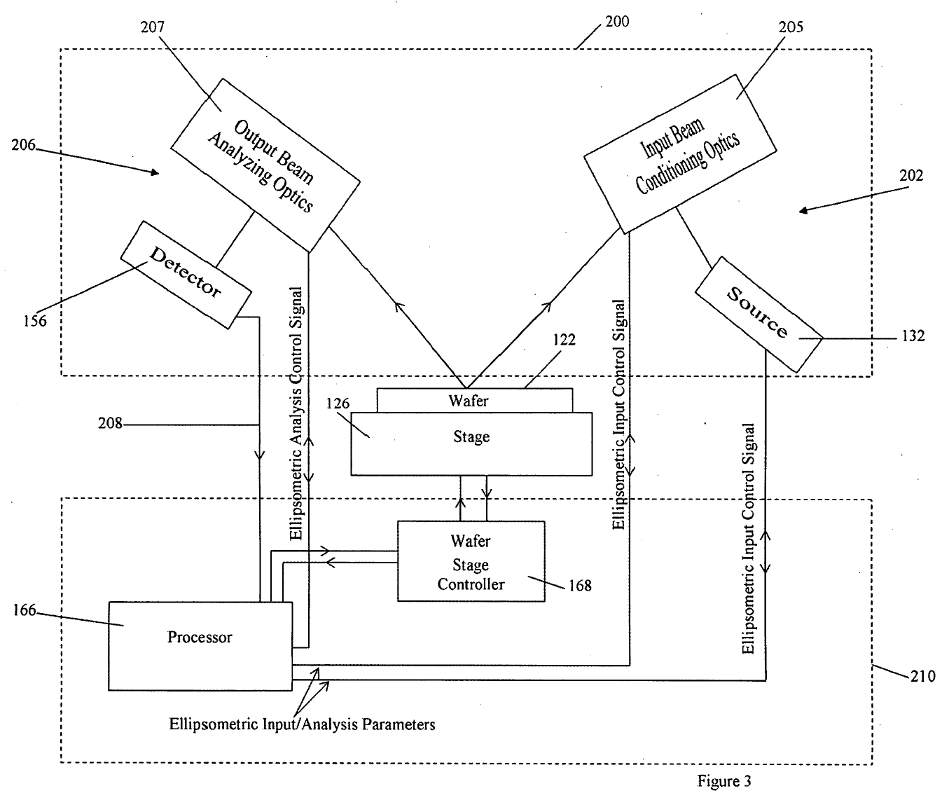

FIG. 2 schematically illustrates one example of how the principles of the present invention can be applied to an imaging optical system, and FIG. 3 schematically illustrates the specific structural and operating principles of the present invention. As shown in FIG. 2, a primary imaging optics includes a lens system 120 which defines a primary optical path by which radiation (light) that originates at the object or reticle 106 is directed through the imaging optics to form an image of the reticle on a wafer surface 122. In FIG. 2, the primary optical path is shown by image rays 124. The wafer surface 122 is a layer of photoresist on a semiconductor wafer that is supported by a wafer stage 126. The wafer stage 126 can be controlled, in a manner described herein, to adjust the position of the wafer surface 122 relative to the lens system 120.

The basic structural and operating principles underlying the present invention are shown in FIG. 3. An optical test assembly 200 includes an input portion 202 that directs light at the wafer image plane 122 under conditions described by ellipsometric input beam conditioning parameters produced by input beam conditioning optics 205, and an output/detection portion 206 that receives reflected light from the wafer image surface 122 under conditions described by ellipsometric output beam parameters produced by output beam optics 207, and produces output 208 (e.g. electronic output from a detector 156 such as a CCD array) based on the received reflected light. A processing control circuit 210 processes the output 208 of the optical test assembly, and produces autofocus correction data based on ellipsometric analysis of (i) the ellipsometric input and output beam parameters and (ii) the output 208 of the optical test assembly. The processing control circuit 210 includes a processor 166, that is in circuit communication with a source 132, and with servo controls for (i) the optical components that form the input beam conditioning optics 205 (e.g. collimator 134, beam splitter 136, additional optics 138) that determine the input beam conditioning parameters, and (ii) the optical components that form the output beam optics 207 (e.g. optics 146, beam splitter 148, lens 150) that determine the output beam parameters.

The processing control circuit 210 is designed to continuously receive output from the detector 156, to provide ellipsometric analysis of that output, and to interface with the wafer stage controller 168, to control the wafer stage 126. Specifically, processor 166 provides appropriate control data to the wafer stage controller 168 to drive the wafer stage 126, thereby to provide the desired positioning of the wafer surface 122 relative to the primary lens system 120. The processing control circuit 210 is also in continuous communication with the servo controls for the components that control the input and output beam optics 205, 207 that determine the input and output beam parameters. Thus, the processing control circuit 210 is capable of continuously controlling the input and output beam parameters, and continuously providing control data to control the wafer stage controller 168 in a manner that corrects for autofocus error.

The ellipsometric input beam conditioning parameters that are controlled by input beam conditioning optics 205 may comprise phase shifting, polarization, input beam wavelength(s), input beam direction(s), and combinations of the foregoing. The ellipsometric output conditioning parameters that are controlled by output beam optics 207 may comprise phase shifting, polarization, chromatic filtering, spatial filtering, and combinations of the foregoing.

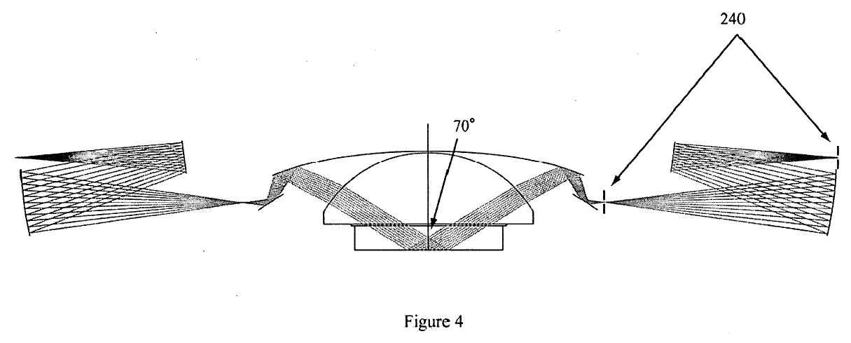

As an example, the ellipsometric output conditioning parameters may comprises spatial filtering configured to reduce diffracted or scattered light in the received reflected light that produces the output. As shown by FIG. 4, such spatial filtering can be produced by one or more filters 240 located in the output/detection portion 206 of the optical test assembly 200. Spatial filtering located at appropriate point(s) on the optical beam path is designed to at least minimize (and preferably eliminate) contributions to the ellipsometric signal caused by diffraction or scattering from patterns on the wafer, or undesired reflections from other surfaces. At large angles of incidence, any patterns on the wafer from earlier lithographically related process steps, will create diffracted or scattered light which will complicate the ellipsometric signal. The reference beam(s) directed through the input beam conditioning optics 205 and at the wafer is collimated. One way to avoid diffraction effects in the ellipsometric signal is to spatially filter the reflected beam(s) at a crossover, where the collimated beam(s) comes to a focus. Two possible locations for the spatial filtering are shown at 240 in FIG. 4. If a beam comes to a point focus, the spatial filter will have a pinhole aperture. If a beam comes to a line focus, a slit is used. More generally, this filter could be a hologram design to reject undesirable diffracted beam components. Such filters, either pinholes, slits, or holograms, will have the added benefit of smoothing the apparent variation of the index of refraction of the underlying structure and making a single substrate-index approximation more valid.

As another example, the ellipsometric input and output/detection conditioning parameters may comprise light at different wavelengths directed at the wafer surface, and reflected from the wafer, and wherein the processing control circuit is configured to produce autofocus correction data based on ellipsometric determination of polarization parameters of the reflected light at the different wavelengths. In this application, input beam “direction”, as an input beam conditioning parameter refers to the angle of incidence on the wafer surface.

In yet another example, the ellipsometric input and output/detection conditioning parameters may be produced from a beam directed at the wafer in different directions, and reflected from the wafer, and wherein the processing control circuit is configured to produce autofocus correction data based on ellipsometric determination of polarization phase change of the reflected light at the different beam directions.

In yet another example, the ellipsometric input and output/detection conditioning parameters may be produced from a beam or set of beams with different wavelengths and different directions, and reflected from the wafer, and wherein the processing control circuit is configured to produce autofocus correction data based on ellipsometric determination of polarization phase change of the reflected light at the different beam directions and wavelengths. In this case, the beams of different wavelengths may or may not be coextensive, and in the case of multiple wavelengths there is advantage of extended dynamic range when multiple wavelength interferometry is applied to determine the autofocus correction.

### DETAILED DESCRIPTION OF EXAMPLES OF HOW PRINCIPLES OF THE INVENTION CAN BE IMPLEMENTED

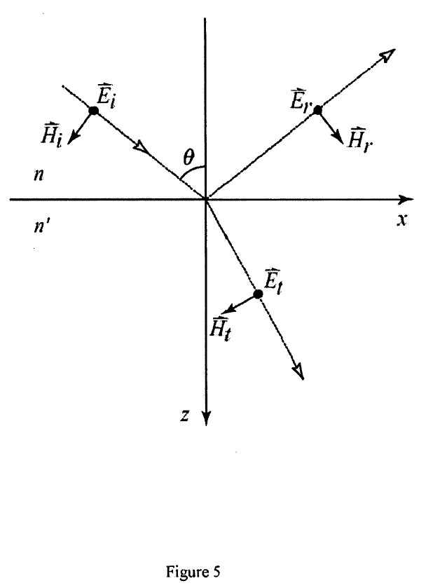

The following description, in conjunction with FIGS. 5-9, provide detailed background and application of the principles of the present invention in providing autofocus phase error introduced into an imaging optical system by a multilayer wafer structure.

a. Preliminaries—A Single Thin Film

In this section we discuss the basic equations that describe how light beams interact with thin film assemblies. A number of text books can be used as basic references for this subject. For example refer to Principles of Optics 7^{th} Edition, by Max Born and Emil Wolf, Cambridge University Press, New York (1999), or Ellipsometry and Polarized Light, by R. M. A. Azzam and N. M. Bashara, North Holland Personal Library, New York (1977), or Thin Film Optical Filters by H. A. Macleod, Adam Hilger Ltd, Bristol (1986), or Polarized Light, fundamentals and Applications by Edward Collett, Marcel Dekkar Inc. New York (1992), each of which is incorporated by reference herein.

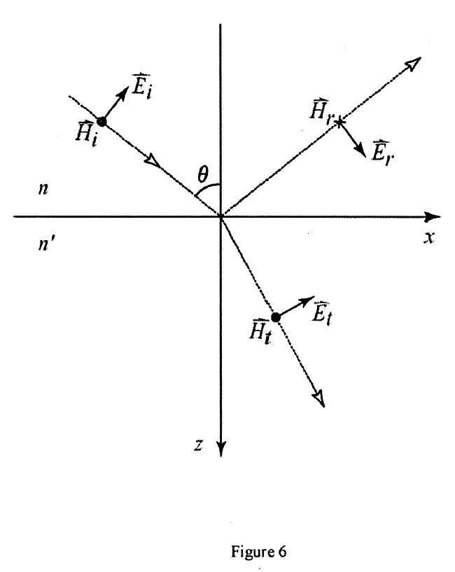

Consider a beam of light incident, at an angle θ₀ on a thin film of thickness d on top of an infinitely thick substrate. Each of these materials, the incident medium, the film, and the substrate have optical admittances that are described by equation (1).

$${η}_{s} = ( n - i k ) \sqrt{\frac{{ɛ}_{0}}{{μ}_{0}}} cos θ \\ {η}_{p} = ( n - i k ) \sqrt{\frac{{ɛ}_{0}}{{μ}_{0}}} \frac{1}{cos θ} \qquad ( 1 )$$

Where n is the real part of the refractive index of the medium. k is the imaginary part of the refractive, also called the extinction coefficient. θ is the angle of propagation relative to the normal to the interface. ε₀ and μ₀ are the vacuum permittivity and permeability respectively. And the subscripts s and p indicate whether the incident light has s- or p-polarization. These two polarization states are illustrated in FIGS. 5 and 6, which show the electric and magnetic field vectors E and H of the incident electric and magnetic fields, respectively (where the subscripts i, r, and t refer to the incident, reflected, and transmitted components, respectively). In the illustrations of FIGS. 5 and 6, s-polarization (FIG. 5) has the electric field perpendicular to the plane of incidence and p-polarization (FIG. 6) has the electric field parallel to the plane of incidence.

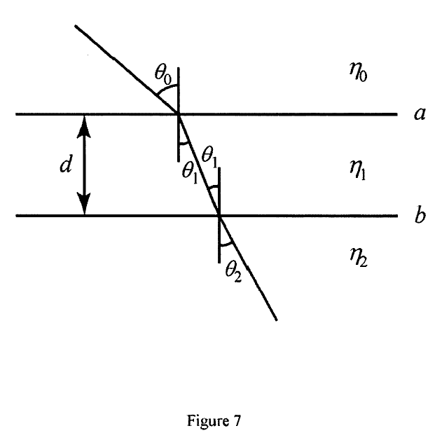

FIG. 7 illustrates the geometry of the layered stricture, where the incident medium has an optical admittance η₀, the film of thickness d has an optical admittance of η₁ and the substrate, of infinite thickness, has optical admittance η₂. The interaction of the electromagnetic field, which is incident on the film at an angle θ₀, propagates in layer 1 with an angle θ₁, and in the substrate at an angle θ₂, is characterized by the quantities B and C in equation (2).

$$( \begin{matrix}B \\ C\end{matrix} ) = ( \begin{matrix}cos {δ}_{1} & ( i sin {δ}_{1} ) / {η}_{1} \\ i {η}_{1} sin {δ}_{1} & cos {δ}_{1}\end{matrix} ) ( \begin{matrix}1 \\ {η}_{2}\end{matrix} ) \qquad ( 2 )$$

Where the quantity δ₁ is the phase gained by the ray in traversing the film of thickness d, index n₁ and extinction coefficient k₁, at an angle θ₁ within the medium of the film. This optical path δ₁ is given explicitly by equation (3), where λ is the vacuum wavelength.

$${δ}_{1} = \frac{2 π ( {n}_{1} - i {k}_{1} )}{λ} d cos {θ}_{1} \qquad ( 3 )$$

The optical admittance of the film, Y, is defined as the ratio of C to B. Equation 4 gives the relative reflected amplitude, or the reflection coefficient, ρ, of the film in terms of the optical admittance of the incident media η₀, the thin film assembly Y and the quantities C and B.

$$ρ = \frac{{η}_{0} - Y}{{η}_{0} + Y} = \frac{{η}_{0} - C / B}{{η}_{0} + C / B} \qquad ( 4 )$$

And the ratio of reflected to incident intensity, also known as the reflectance, is given by equation (5), where the * indicates complex conjugate.

$$R = ( \frac{{η}_{0} - Y}{{η}_{0} + Y} ) {( \frac{{η}_{0} - Y}{{η}_{0} + Y} )}^{*} = ( \frac{{η}_{0} - C / B}{{η}_{0} + C / B} ) {( \frac{{η}_{0} - C / B}{{η}_{0} + C / B} )}^{*} \qquad ( 5 )$$

The quantities B, C, ρ and R can be calculated for either s- or p-polarization by substitution of the appropriate version of η, from equation (1).

b. Multilayer Film

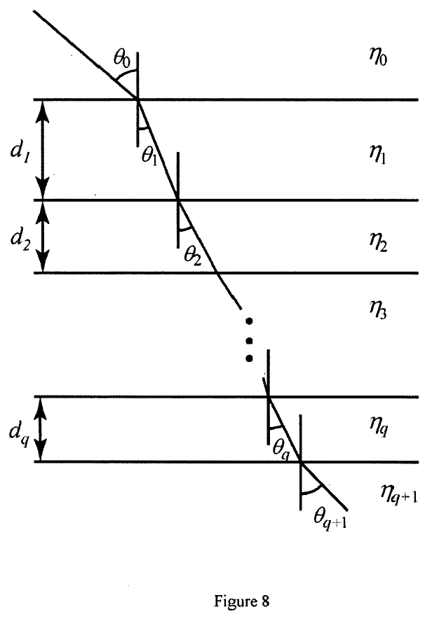

Consider the case of a multilayer assembly, where additional layers are inserted between the incident medium and the substrate, as shown in FIG. 8. As shown in the figure, d, θ and h are subscripted according to the occurrence of their respective media from the top of the assembly starting with d₀, θ₀ and h₀ in the incident medium and ending with d_{q+1}, θ_{q+1} and h_{q+1} in the substrate. In this case B and C are found by equation (6), where capital pi is the matrix product operator.

$$( \begin{matrix}B \\ C\end{matrix} ) = [ {\prod }_{r = 1}^{q} ( \begin{matrix}cos {δ}_{r} & ( i sin {δ}_{r} ) / {η}_{r} \\ {iη}_{r} sin {δ}_{r} & cos {δ}_{r}\end{matrix} ) ] ( \begin{matrix}1 \\ {η}_{q + 1}\end{matrix} ) \qquad ( 6 )$$

The reflection coefficient and reflectance, in this case, are still calculated using equations (4) and (5).

c. Ellipsometric Measurements

In ellipsometry, we essentially measure the relative complex reflectivity of an assembly, (see for example Collett). Specifically, the two measured quantities ψ and Δ are related to the relative amplitude coefficient of reflection by equation (7), where the subscripts s and p represent the values for s- and p-polarization respectively, and the subscript R indicates that these are relative values.

$${ρ}_{R} = \frac{{ρ}_{p}}{{ρ}_{s}} = \frac{{η}_{0} - {Y}_{p}}{{η}_{0} + {Y}_{p}} \frac{{η}_{0} + {Y}_{s}}{{η}_{0} - {Y}_{s}} \\ ψ = {tan}^{- 1} \vert {ρ}_{R} \vert \\ Δ = arg ( {ρ}_{R} ) \qquad ( 7 )$$

d. One Method of Measuring ψ and Δ

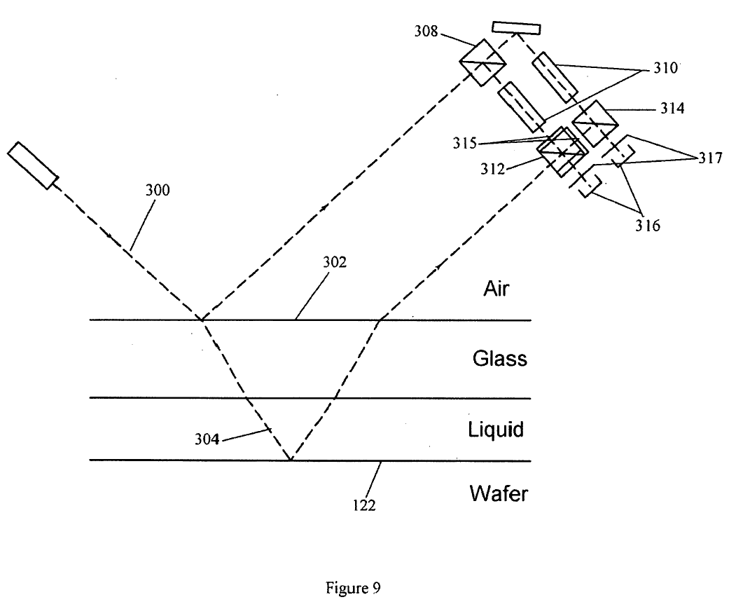

FIG. 9 illustrates a simple interferometric ellipsometer concept with a reference beam 300 that reflects off of an air-glass interface 302 and is subsequently interfered with a measurement beam 304 that reflects off of the wafer thin-film surface 122. The reference beam 300 is split into s- and p-polarization components by a polarizing beam splitter (PBS) 308 and both of the resulting beams are passed through phase shifting devices (such as electro-optic modulators 310). The measurement beam 304 is also split into s- and p-polarizations with a PBS 312 that also functions to combine the s-polarization of the test beam with the s-polarization of the reference beam. A third PBS 314 is used to combine the p-polarizations. Two half-wave-plates 315 are inserted to invert the polarization to make the beam combining possible. Analyzers (linear polarizers) 317 are placed in front of each detector to make the beams interfere.

Given an interferometric ellipsometer of the type shown in FIG. 9, we can write down the Jones matrices that describe the polarization states for the reference beam and test beam (also known as the measurement beam) in terms of the eigen-polarizations; s- and p-polarization. For the reference beam this includes the effects of the entire path, including the phase shift δ generated by the phase shifting mechanism 310 and the constant relative phase shift δₒ due to the path difference between reference and test. Also included are the complex transmittances for the s- and p-polarizations, that incorporate the effects of the air-glass interface, beam splitters, wave plates and the mirror are captured in equation (8), where r represents the overall transmittance of a given path. The subscript ref indicates that this is the reference beam path, and the superscripts s and p indicate that these are for s- and p-polarization respectively.

$${J}_{ref} = ( \begin{matrix}{r}_{ref}^{s} {e}^{{iδ}_{ref}^{s}} & 0 \\ 0 & {r}_{ref}^{s} {e}^{{iδ}_{ref}^{s}}\end{matrix} ) {e}^{i ( δ + {δ}_{o} )} \qquad ( 8 )$$

The Jones matrix for the test arm can be split into a product of two Jones matrices; one for the wafer itself and another for the rest of the system. This is made especially easy since both parts share common eigen-polarizations—this is not strictly true since the half-wave-plates convert s- into p-polarization, but if we assume these retarders are perfect and just allow the coordinate systems of the Jones matrices to follow this inversion it all works out. The two resulting Jones matrices are given by equations (9) and (10) where the subscripts w and i stand for wafer and test,

$$\begin{matrix}{J}_{wafer} = ( \begin{matrix}{r}_{w}^{s} {e}^{{iδ}_{w}^{s}} & 0 \\ 0 & {r}_{w}^{p} {e}^{{iδ}_{w}^{p}}\end{matrix} ) & ( 9 ) \\ {J}_{test} = ( \begin{matrix}{r}_{t}^{s} {e}^{{iδ}_{t}^{s}} & 0 \\ 0 & {r}_{t}^{p} {e}^{{iδ}_{t}^{p}}\end{matrix} ) & ( 10 )\end{matrix}$$

The final ingredient is the input Jones vector representing the incident beam. In this case, the beam could have almost any polarization state as long as there is significant energy in the s- and p-polarization components.

$${\overline{E}}_{i n} = ( \begin{matrix}{E}_{s} {e}^{{iθ}_{s}} \\ {E}_{p} {e}^{{iθ}_{p}}\end{matrix} ) \qquad ( 11 )$$

Applying the Jones matrices, we have the two output Jones vectors.

$$\begin{matrix}\begin{matrix}{\overline{E}}_{ref} = {e}^{i ( δ + {δ}_{0} )} ( \begin{matrix}{r}_{ref}^{s} {e}^{{iδ}_{ref}^{s}} & 0 \\ 0 & {r}_{ref}^{p} {e}^{{iδ}_{ref}^{p}}\end{matrix} ) ( \begin{matrix}{E}_{s} {e}^{{iθ}_{s}} \\ {E}_{p} {e}^{{iθ}_{p}}\end{matrix} ) \\ = {e}^{i ( δ + {δ}_{0} )} ( \begin{matrix}{E}_{s} {r}_{ref}^{s} {e}^{i ( {θ}_{s} + {δ}_{ref}^{s} )} \\ {E}_{p} {r}_{ref}^{p} {e}^{i ( {θ}_{p} + {δ}_{ref}^{p} )}\end{matrix} )\end{matrix} & ( 12 ) \\ \begin{matrix}{\overline{E}}_{test} = ( \begin{matrix}{r}_{t}^{s} {e}^{{iδ}_{t}^{s}} & 0 \\ 0 & {r}_{t}^{p} {e}^{{iδ}_{t}^{p}}\end{matrix} ) ( \begin{matrix}{r}_{w}^{s} {e}^{{iδ}_{w}^{s}} & 0 \\ 0 & {r}_{w}^{p} {e}^{{iδ}_{w}^{p}}\end{matrix} ) ( \begin{matrix}{E}_{s} {e}^{{iθ}_{s}} \\ {E}_{p} {e}^{{iθ}_{p}}\end{matrix} ) \\ = ( \begin{matrix}{E}_{s} {r}_{t}^{s} {r}_{w}^{s} {e}^{i ( {θ}_{s} + {δ}_{t}^{s} + {δ}_{w}^{s} )} \\ {E}_{p} {r}_{t}^{p} {r}_{w}^{p} {e}^{i ( {θ}_{p} + {δ}_{t}^{p} + {δ}_{t}^{p} )}\end{matrix} )\end{matrix} & ( 13 )\end{matrix}$$

The arrangement of waveplates 315 and PBS cubes 308, 312, 314 and polarizers 317 placed just before the detectors 316 in FIG. 9, allow effective separation of the s- and p-polarizations so that the two detectors receive signals that are proportional to the modulus square of the individual components of the sum of these two Jones vectors.

$$\begin{matrix}{S}_{s} = {‖ {E}_{s} ( {r}_{ref}^{s} {e}^{i ( {θ}_{s} + {δ}_{ref}^{s} + δ + {δ}_{0} )} + {r}_{t}^{s} {r}_{w}^{s} {e}^{i ( {θ}_{s} + {δ}_{t}^{s} + {δ}_{w}^{s} )} ) ‖}^{2} \\ = {E}_{s}^{2} [ \begin{matrix}{{r}_{ref}^{s}}^{2} + {( {r}_{t}^{s} {r}_{w}^{s} )}^{2} + \\ 2 {r}_{ref}^{s} {r}_{t}^{s} {r}_{w}^{s} cos ( {δ}_{ref}^{s} + δ + {δ}_{0} - {δ}_{t}^{s} - {δ}_{w}^{s} )\end{matrix} ]\end{matrix} \\ \begin{matrix}{S}_{p} = {‖ {E}_{p} ( {r}_{ref}^{p} {e}^{i ( {θ}_{p} + {δ}_{ref}^{p} + δ + {δ}_{0} )} + {r}_{t}^{p} {r}_{w}^{p} {e}^{i ( {θ}_{p} + {δ}_{t}^{p} + {δ}_{w}^{p} )} ) ‖}^{2} \\ = {E}_{p}^{2} [ \begin{matrix}{{r}_{ref}^{p}}^{2} + {( {r}_{t}^{p} {r}_{w}^{p} )}^{2} + \\ 2 {r}_{ref}^{p} {r}_{t}^{p} {r}_{w}^{p} cos ( {δ}_{ref}^{p} + δ + {δ}_{0} - {δ}_{t}^{p} - {δ}_{w}^{p} )\end{matrix} ]\end{matrix} \qquad ( 14 )$$

Each of the r's and δ's (except for those associated with the wafer) can be determined by a combination of blocking reference and test paths and measuring well characterized surfaces in place of the wafer. Then stepping the phase between measurements can be used to determine the phases of the s- and p-polarization channels relative to the reference beams. For simplicity, these phases are denoted Phase[Sₛ] and Phase[Sₚ] respectively and are used in equation (15) to determine the ellipsometric parameter Δ.

Δ=(Phase[Sₚ]−Phase[Sₛ])+(δ_{ref}^{s}−δₜ^{s})−(δ_{ref}^{p}−δₜ^{p}) (15)

Furthermore, an additional sensor placed in beam 300 can be used to monitor Eₛ² and Eₚ² and used in equation (16), with the values of the signals averaged over δ, indicated by angle brackets, to determine the ellipsometric parameter ψ.

$$Tan ( ψ ) = \frac{{r}_{w}^{p}}{{r}_{w}^{s}} = \sqrt{( \frac{〈 {S}_{p} 〉 / {E}_{p}^{2} - {( {r}_{ref}^{p} )}^{2}}{〈 {S}_{s} 〉 / {E}_{s}^{2} - {( {r}_{ref}^{s} )}^{2}} ) {( \frac{{r}_{t}^{s}}{{r}_{t}^{p}} )}^{2}} \qquad ( 16 )$$

In order to take advantage of equation (15) we must first estimate values for the s- and p-phase differences between the reference and test paths—the values within the last two sets of parenthesis of (15). We must also estimate the modulus of the transmittances for the reference path and ratio of the s- and p-polarization transmittances for the test path to take advantage of equation (16). Each of these five quantities can be measured directly or through calibration with a set of well known wafer surfaces.

e. Ellipsometric Inversion

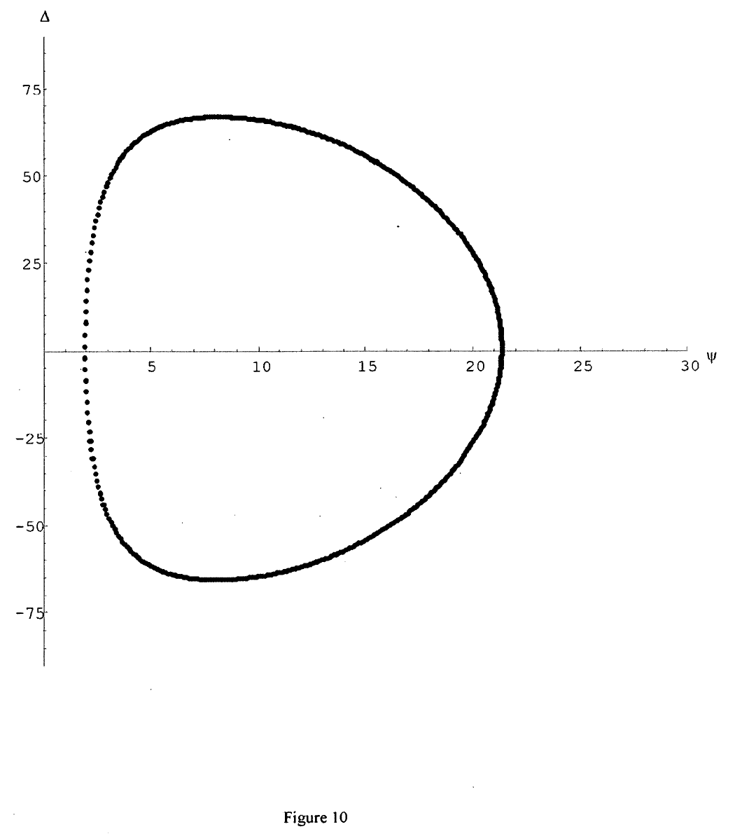

Once a method of measuring ψ and Δ has been devised, the next step is to use that information to determine the details of the thin film assembly on the wafer. However, a single measurement of ψ and Δ is not usually sufficient to infer the unknown thicknesses and indices of refraction. In the case of a simple layer of resist on silicon, one may measure in advance the indices for all materials and then the only unknown is the thickness of the resist. Supposing that the resist has an index of refraction of 1.4, FIG. 10 illustrates the computed relationship between ψ and Δ as the thickness of the resist goes from 0 to 523 nm. In this example, the wavelength is 632.8 nm.

In this simulation, the light is incident on the resist in water at an angle of 70° and the resist is deposited on a substrate of crystalline silicon. Over this range of resist thickness, the curve traces out a single lap around this closed curve.

This plot shows that for given a pair of values of ψ and Δ (under the measurement conditions described) the thickness of the resist can be determined to some multiple of 523 nm. In all realistic cases, the thickness of the resist is known in advance to within a fraction of this value and so this ambiguity poses no real difficulty.

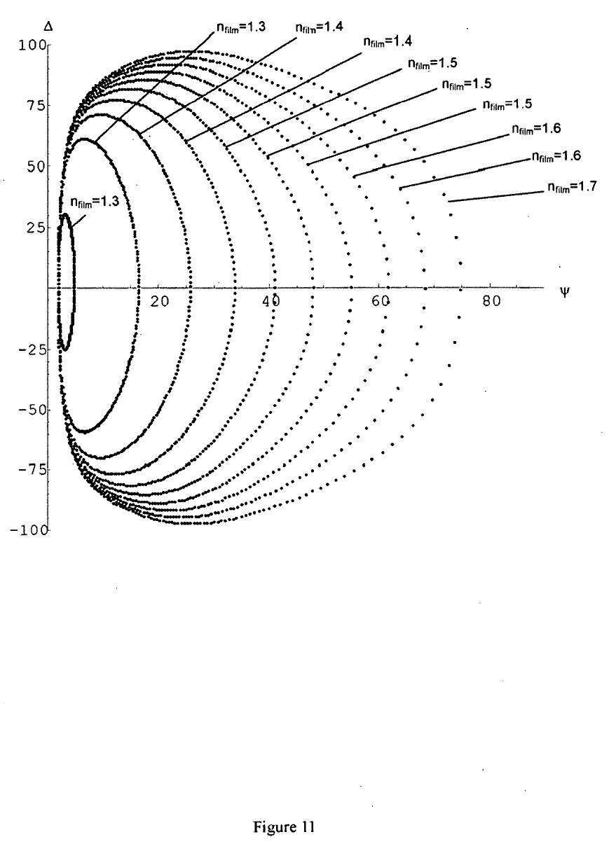

FIG. 11 is a plot of the simulated ellipsometric parameters Δ vs ψ as the thickness of the resist is varied to trace out the contours of equal index of refraction. In this simulation, the light is incident on the resist in water at an angle of 70° and the resist is deposited on a substrate of crystalline silicon. The smallest index of refraction is 1.34 (corresponding to the smallest closed curve) and the largest is 1.70 (corresponding to the largest closed curve).

From FIG. 11, we can see that when the resist is non-absorbing at the measurement wavelength, values of ψ and Δ are unique for values of index and thickness, within some periodic dependence on thickness. So, in a noise free scenario, it is still sufficient to make a single measurement of ψ and Δ to determine thickness and index.

The situation becomes more complicated when there are more unknowns; when the resist is absorbing, when the underlying substrate is unknown, when there is a bottom anti-reflection coating (BARC), or when the substrate has a printed pattern consisting of regions of different materials having different indices of refraction. In all these cases, the contours of FIG. 11 deform in predictable ways depending on the various parameters as determined by equations (5), (6) and (7). The problem then becomes a matter of making enough independent measurements to determine the desired unknowns. The independent measurements are typically generated by changing the angle of incidence and/or the wavelength. Once the measured values of ψ and Δ are obtained and a suitable mathematical model is constructed, it is a matter of inverting the highly non-linear relationship between the measured values and the desired unknowns. This inversion process is made easier with any a priori information available that can be used to bound the solution e.g., index of the resist, approximate thickness of the resist, BARC thickness and index and approximate range of the substrate index. The inversion process itself can be carried out using some non-linear optimization algorithm like down-hill simplex, or Levenberg-Marquardt [see for example Numerical Recipes in C: The Art of Scientific Computing, by Press, Flannery, Teukolsky and Vetterling, Cambridge University Press 1992, which is incorporated by reference herein]. An alternative is to compute or measure a range of possible solutions in advance to determine a look-up table or some pre-inverted mathematical relationship like a polynomial fit.

### SOME ALTERNATIVE STRATEGIES FOR PRACTICING THE PRINCIPLES OF THE PRESENT INVENTION

It is contemplated that the principles of the present invention can be practiced in several alternative ways. For example, in one alternative, the optical test assembly 200 and processing control circuit 210 may be configured to pre-map the wafer surface 122 prior to imaging of the wafer, to produce the auto focus correction data during imaging of the wafer. In another alternative, the optical test assembly and processing control circuit are configured to partially pre-map the wafer surface prior to imaging of the wafer, and to also operate the optical test assembly and processing circuit in situ during imaging of the wafer surface to produce the auto focus correction data during the imaging of the wafer. In still another alternative, the optical test assembly and processing control are operated in situ during imaging of the wafer surface to produce the auto focus correction data during the imaging of the wafer.

Still further, the principles of the present invention can be practiced in a system and method with a measurement optical path that is of the “through the lens” type disclosed in U.S. patent application Ser. No. 11/544,833, where a wafer imaging system includes a primary optical path for producing an image on the wafer surface 122, and wherein the input and output/detection portions of the optical test assembly extend at least partially through the primary optical path. FIG. 2 schematically shows how the principles of the present invention can be provided in such a “through the lens” (TTL) system and method. In FIG. 2, the measurement optical path is schematically illustrated by image rays 130 that are directed through part of the imaging optics (with an aperture stop 158), reflects off of the wafer surface 122, passes back through the part of imaging optics (including the aperture stop 158) and finally ends up on the detector 156. Thus, an image of the measurement source 132 (i.e. a real or virtual image) that is projected by the measurement optical path is transmitted at least partially through the imaging optics 120. The optical components 205, 207, that produce the input beam conditioning parameters and the output beam parameters form respective parts of the measurement optical path.

### Additional Comments

A system and method that corrects for autofocus error in the foregoing manner is useful with a number of imaging optical systems. For example, it can be used with “wet” imaging optical system, in which the imaging of the wafer surface 122 is through an immersion fluid layer, and also with a “dry” imaging optical system, in which imaging of the wafer surface 122 is through a medium such as a gas, air or a vacuum. In addition, the measurement optical path may or may not contain optics which compensate for aberrations generated by the imaging optics. This compensation could be achieved with reflective, refractive or diffractive nulling optics, and these optics could be placed before or after overlap with the imaging optical path.

Additionally, while disclosed in connection with one form of metrology system (e.g. for a lithographic imaging optical system), the principles of the present invention can be used with various types of lithographic imaging optical systems. For example, in FIG. 1, the lithographic imaging optical system shown in full lines is a scanning lithographic imaging optical system, in which the scanning slit 104 and the reticle 106 have openings (shown in full lines) that move in synchronism to produce the image at the image plane 110. The lithographic imaging optical system could also be of the “step and repeat type”, which is well known to those in the art, and in which the scanning slit 104, the reticle 106 have larger openings that are shown in dashed lines, and are moved in a stepped fashion to produce the image shown in dashed lines in the image plane 110. In addition, an imaging optical system according to the principles of the present invention provides a measurement image that can produce input to any number of metrology systems including but not limited to a Shack-Hartmann wavefront sensor, a confocal microscope, interferometric confocal microscope, a distance measuring interferometer, a phase measuring interferometer, bi-homodyne interferometer, heterodyne interferometer, star test, knife-edge test, wire test, Hartmann test, shearing interferometer, curvature sensor, etc. Still further, an imaging optical system according to the present invention can be configured with a measurement beam that examines a surface under investigation other than a wafer located at an image plane. For example, in a lithographic imaging optical system of the type shown in FIG. 1, the principles of the present invention can be used to examine the reticle 106 as a surface under investigation.

Also, this invention can be utilized in an immersion type exposure apparatus that takes suitable measures (e.g. pressure and/or height) for a liquid (e.g. a liquid reservoir of an immersion lithography apparatus). For example, PCT patent application WO 99/49504 discloses an exposure apparatus in which a liquid is supplied to the space between a substrate (wafer) and an imaging lens system in an exposure process. The pressure and/or height of liquid in a liquid reservoir of an immersion lithography apparatus is obtained by a measurement device. The pressure and/or height can be used to determine the height and/or tilt of the substrate. U.S. Pat. No. 7,038,760 corresponds to WO 99/49504. As far as permitted, the disclosures of WO 99/49504 and U.S. Pat. No. 7,038,760 are incorporated herein by reference.

Still further, the principles of the present invention, while particularly useful in a wafer imaging system, may also be applied to other types of optical imaging systems such as an imaging optical system for a microscope or other forms of optical inspection systems. In such optical imaging systems, an optical test assembly would (a) direct light at a surface under investigation, under conditions described by ellipsometric input beam conditioning parameters, (b) receive reflected light from the surface under investigation under conditions described by ellipsometric output beam conditioning parameters, and (c) produce output based on the received reflected light; and a control circuit would process the output of the optical test assembly, and produce autofocus correction data based on ellipsometric analysis of (i) the ellipsometric input and output beam conditioning parameters and (ii) the output of the optical test assembly.

With the foregoing disclosure in mind, it is believed that various adaptations of an optical imaging system and method, that corrects for autofocus errors, based on ellipsometric principles, according to the principles of the present invention, will be apparent to those in the art.

1. A system producing data for correcting autofocus error in an imaging system, comprising,
a. an optical test assembly with an input portion that directs light at a surface under investigation, under conditions described by ellipsometric input beam conditioning parameters, and an output/detection portion that receives reflected light from the surface under investigation under conditions described by ellipsometric output beam conditioning parameters, and produces output based on the received reflected light; and
b. a processing control circuit that processes the output of the optical test assembly, and produces autofocus correction data based on ellipsometric analysis of (i) the ellipsometric input and output beam conditioning parameters and (ii) the output of the optical test assembly.

2. The system defined in claim 1, wherein the imaging system is a wafer imaging system, the input portion directs light at a wafer surface, and the output/detection portion receives reflected light from the wafer surface.

3. The system defined in claim 2, wherein the ellipsometric input beam conditioning parameters comprise phase shifting, polarization, input beam wavelength(s), input beam direction(s), and combinations of the foregoing, and the ellipsometric output conditioning parameters comprise phase shifting, polarization, chromatic filtering, spatial filtering, and combinations of the foregoing.

4. The system defined in claim 2, wherein the ellipsometric output conditioning parameters comprises spatial filtering configured to reduce diffracted or scattered light in the received reflected light that produces the output.

5. The system defined in claim 4, wherein the spatial filtering is produced by one or more filters located in the output/detection portion of the optical test assembly.

6. The system defined in claim 2, wherein the optical test assembly and processing control circuit are configured to pre-map the wafer surface prior to imaging of the wafer surface, to produce the auto focus correction data during imaging of the wafer.

7. The system defined in claim 1, wherein the optical test assembly and processing control circuit are configured to partially pre-map the water surface prior to imaging of the wafer surface, and to also operate the optical test assembly and processing circuit in situ during imaging of the wafer surface to produce the auto focus correction data during the imaging of the wafer.

8. The system defined in claim 2, wherein the optical test assembly and processing control are operated in situ during imaging of the wafer surface to produce the auto focus correction data during the imaging of the wafer.

9. The system defined in claim 2, wherein the ellipsometric input and output/detection conditioning parameters comprise light at different wavelengths directed at the wafer, and reflected from the wafer, and wherein the processing control circuit is configured to produce autofocus correction data based on ellipsometric determination of polarization parameters of the reflected light at the different wavelengths.

10. The system defined in claim 2, wherein the conditions described by ellipsometric input and output/detection conditioning parameters comprise a beam directed at the wafer in different directions, and reflected from the wafer, and wherein the processing control circuit is configured to produce autofocus correction data based on ellipsometric determination of polarization phase change of the reflected light at the different beam directions.

11. The system defined in claim 2, wherein the conditions described by ellipsometric input and output/detection conditioning parameters comprise a beam or set of beams directed at the wafer with different wavelengths and different directions, and reflected from the wafer, and wherein the processing control circuit is configured to produce autofocus correction data based on ellipsometric determination of polarization phase change of the reflected light at the different beam directions and wavelengths.

12. The system defined in claim 2, wherein a wafer imaging system includes a primary optical path for producing an image on the wafer surface, and wherein the input and output/detection portions of the optical test assembly extend at least partially through the primary optical path.

13. A method of producing data for correcting autofocus error in an imaging system, comprising,
a. operating an optical test assembly with an input portion that directs light at a surface under investigation, under conditions described by ellipsometric input beam conditioning parameters, and an output/detection portion that receives reflected light from the surface under investigation, under conditions described by ellipsometric output beam conditioning parameters, and produces output based on the received reflected light; and
b. operating a processing control circuit that processes the output of the optical test assembly, and produces autofocus correction data based on ellipsometric analysis of (i) the ellipsometric input and output beam conditioning parameters and (ii) the output of the optical test assembly.

14. The method of claim 13, wherein the imaging system is a wafer imaging system, and wherein the surface under investigation is a wafer surface.

15. The method defined in claim 14, wherein the optical test assembly is operated under conditions described by ellipsometric input beam conditioning parameters that comprise phase shifting, polarization, input beam wavelength(s), input beam direction(s), and combinations of the foregoing, and the optical test assembly is operated under conditions described by ellipsometric output conditioning parameters that comprise phase shifting, polarization, chromatic filtering, spatial filtering, and combinations of the foregoing.

16. The method defined in claim 15, wherein the optical test assembly is operated under conditions described by ellipsometric output conditioning parameters that comprises spatial filtering configured to reduce diffracted or scattered light in the received reflected light that produces the output.

17. The method defined in claim 16, wherein the optical test assembly is operated under ellipsometric output conditions comprising spatial filtering produced by one or more filters located in the output/detection portion of the optical test assembly.

18. The method defined in claim 14, wherein the optical test assembly and processing control circuit are operated to pre-map the wafer surface prior to imaging of the wafer surface, to produce the auto focus correction data during imaging of the wafer.

19. The method defined in claim 14, wherein the optical test assembly and processing control circuit are operated to partially pre-map the water surface prior to imaging of the wafer surface, and to also during imaging of the wafer surface to produce the auto focus correction data during the imaging of the wafer.

20. The method defined in claim 14, wherein the optical test assembly and processing control are operated in situ during imaging of the wafer surface to produce the auto focus correction data during the imaging of the wafer.

21. The method defined in claim 14, wherein the conditions described by ellipsometric input and output/detection conditioning parameters comprise light at different wavelengths directed at the, and reflected from the wafer, and wherein the processing control circuit is configured to produce autofocus correction data based on ellipsometric determination of polarization parameters of the reflected light at the different wavelengths.

22. The method defined in claim 14, wherein the conditions described by ellipsometric input and output/detection conditioning parameters comprise a beam directed at the wafer in different directions, and reflected from the wafer, and wherein the processing control circuit is configured to produce autofocus correction data based on ellipsometric determination of polarization phase change of the reflected light at the different beam directions.

23. The method defined in claim 14, wherein the conditions described by ellipsometric input and output/detection conditioning parameters comprise a beam or set of beams with different wavelengths and different directions directed at the wafer and reflected from the wafer, and wherein the processing control circuit is configured to produce autofocus correction data based on ellipsometric determination of polarization phase change of the reflected light at the different beam directions and wavelengths.

24. The method defined in claim 14, wherein the wafer is imaged through a primary optical path, to produce an image on the wafer surface, and wherein the input and output/detection portions of the optical test assembly extend at least partially through the primary optical path.
